(19) United States
(12) Patent Application Publication
(10) Pub. No.: US 2015/0217247 A1
(43) Pub. Date: Aug. 6, 2015

(54) SURFACTANT COMPOSITION WITH LOW DYNAMIC SURFACE TENSION

(71) Applicants: Xiaohua Wang, Shanghai (CN); Wanglin Yu, Pearland, TX (US)

(72) Inventors: Xiaohua Wang, Shanghai (CN); Wanglin Yu, Pearland, TX (US)

(73) Assignee: Dow Global Technologies LLC, Midland, MI (US)

(21) Appl. No.: 14/421,479

(22) PCT Filed: Sep. 14, 2012
(86) PCT No.: PCT/CN2012/081382

§ 371 Date: Feb. 13, 2015

(51) Int. Cl. B01F 17/00; C09J 11/06

(52) U.S. Cl. CPC B01F 17/0092; B01F 17/0057; B01F 17/0021; C09J 11/06; C08K 5/42

(57) ABSTRACT

Provided are surfactant compositions that are useful as wetting agents in aqueous formulations. The compositions comprise (a) a dialkyl sulfosuccinate compound of formula (I); and (b) a secondary alcohol alkoxylate compound of formula (II): wherein R, M, R¹, R², and n are as defined herein.

### FIELD

This invention relates generally to a surfactant composition that is useful as a wetting agent in aqueous formulations. The composition comprises a dialkyl sulfosuccinate compound and a branched secondary alcohol ethoxylate compound.

### BACKGROUND

Surfactants are widely used as wetting agents in waterborne formulations. Modern surfactants often have properties that are specifically tailored to the performance requirements of the particular application in which they are used.

Some industrial processes that utilize surfactants involve dynamic surface conditions in which the speed of new surface creation is high, for instance in applications such as printing, rolling coating, curtain coating, ink jetting, spraying coating, etc. Such processes typically require that surfactants included in the applied formulation exhibit the ability to lower the surface tension and wet the substrate rapidly. Dynamic surface tension (DST) is generally used to measure the capability of one solution to lower surface tension and wet substrate under high speed process conditions. Many known surfactants, however, are unable to provide rapid wetting and are therefore insufficient to meet the requirements of industries requiring such properties.

The problem addressed by this invention is the provision of new surfactant compositions that exhibit properties suitable for use under dynamic surface conditions.

### STATEMENT OF INVENTION

We have now found that compositions containing a dialkyl sulfosuccinate compound and a branched secondary alcohol ethoxylate compound, as described below, exhibit significantly reduced dynamic surface tension. In addition, the compositions may also exhibit reduced equilibrium surface tension (EST) without increased foaming. Low EST and less foam are desired for many applications, including those involving dynamic surface creation as described above.

In one aspect, there is provided a composition comprising:
(a) a dialkyl sulfosuccinate compound of formula I:

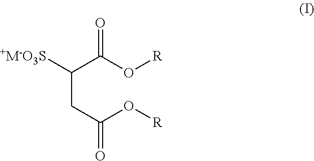

wherein R at each occurrence is independently linear or branched C₆-C₁₀ alkyl, and M⁺ is a monovalent or divalent cation; and
(b) a secondary alcohol alkoxylate compound of formula II:

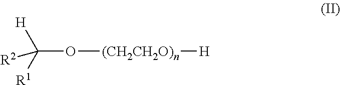

wherein R¹ and R² are independently linear or branched C₁-C₁₄ alkyl, wherein the group formed by R¹, R² and the carbon to which they are attached contains 7 to 16 carbon atoms, and n is from 1 to 20.

In another aspect, there is provided a method for reducing surface tension in a formulation, the method comprising adding to the formulation an effective amount of a composition as described herein.

In a further aspect, there is provided a formulation containing a surfactant to reduce surface tension, the formulation being selected from an adhesive formulation, an agrochemical formulation, a coating formulation, an ink formulation, a formulation for use in textiles or leather, a rolling coating formulation, a curtain coating formulation, a printing formulation, and a spray coating formulation, wherein the surfactant comprises a composition as described herein.

### BRIEF DESCRIPTION OF THE FIGURES

FIG. 1. is a plot of dynamic surface tension of a lamination adhesive formulation with various surfactants (room temperature).

FIG. 2. is a plot of dynamic surface tension of a lamination adhesive formulation with various surfactants after storage of the formulation at 50° C. for 10 days (tests are performed at room temperature).

### DETAILED DESCRIPTION

Unless otherwise indicated, numeric ranges, for instance as in “from 2 to 10,” are inclusive of the numbers defining the range (e.g., 2 and 10).

Unless otherwise indicated, ratios, percentages, parts, and the like are by weight.

As noted above, the invention provides a composition comprising (a) a dialkyl sulfosuccinate compound of formula I and (b) a secondary alcohol alkoxylate compound of formula II. The composition provides advantageously low dynamic surface tension. In addition, the composition may also provide additional benefits, including desirably low equilibrium surface tension, low foaming properties, lower contact angle on low energy surfaces, indicating favorable wetting properties.

The dialkyl sulfosuccinate compound of the composition may be represented by the formula I:

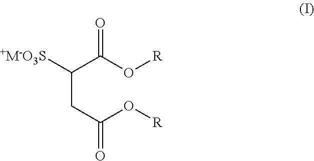

wherein R at each occurrence is independently linear or branched C₆-C₁₀ alkyl, and M⁺ is a monovalent or divalent cation.

In some embodiments, R in formula I is the same at each occurrence.

In some embodiments, R in formula I is linear or branched C₇-C₉ alkyl. In some embodiments, R is 2-ethylhexyl (CH₃CH₂CH₂CH₂CH(CH₂CH₃)CH₂—.

In some embodiments, M⁺ in formula I is a monovalent cation. In some embodiments, M⁺ is sodium or potassium or ammonium ion. In some embodiments, M⁺ is sodium ion.

The secondary alcohol alkoxylate compound of the composition of the invention may be represented by the following formula II:

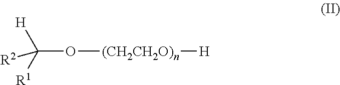

wherein R¹ and R² are independently linear or branched C₁-C₁₄ alkyl, wherein the group formed by R¹, R² and the carbon to which they are attached contains 7 to 16 carbon atoms, and n is from 1 to 20.

In some embodiments, the group formed by R¹, R² and the carbon to which they are attached contains 9 to 12 carbon atoms.

In some embodiments of the invention, R¹ is C₃-C₁₂ alkyl, alternatively C₃-C₈ alkyl, or alternatively C₄-C₆ alkyl.

In some embodiments of the invention, R² is C₃-C₁₂ alkyl, alternatively C₄-C₁₀ alkyl, or alternatively C₆-C₈ alkyl.

The variable “n” in the formula II compounds describes the average molar amount of charged ethylene oxide relative to one mole of the alcohol starter used in making the compound. In some embodiments, n is at least 2, alternatively at least 3, or alternatively at least 4. In some embodiments, n is 18 or less, alternatively 15 or less, or alternatively 12 or less. In some embodiments, n falls in the range of from 2 to 15, alternatively 2 to 10.

In some embodiments of the invention, the secondary alcohol alkoxylate of formula II is of the formula II-a;

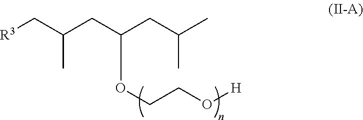

wherein R³ is H or iso-propyl and n is as defined above.

In some embodiments, the secondary alcohol alkoxylate is of the formula:

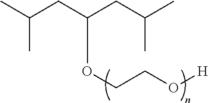

wherein n is as defined above. In some embodiments, n is 2 to 3.

In some embodiments, the secondary alcohol alkoxylate is of the formula:

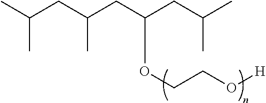

wherein n is as defined above. In some embodiments, n is from 3 to 8.

In some embodiments, the weight ratio of the dialkyl sulfosuccinate compound of formula I and the secondary alcohol alkoxylate compound of formula II in the composition of the invention is from 99:1 to 1:99, alternatively from 9:1 to 1:9, alternatively from 9:1 to 1:1 or alternatively from 1:1 to 1:9.

In some embodiments, R³ in the formula II compound is iso-propyl, n is 3, and the weight ratio of the dialkyl sulfosuccinate compound to the secondary alcohol alkoxylate compound is from 9:1 to 1:1.

In some embodiments, R³ is iso-propyl, n is 5, and the weight ratio of the dialkyl sulfosuccinate compound to the secondary alcohol alkoxylate compound is from 9:1 to 1:9.

In some embodiments, R³ is iso-propyl, n is 8, and the weight ratio of the dialkyl sulfosuccinate compound to the secondary alcohol alkoxylate compound is from 1:1 to 1:9.

In some embodiments, R³ is H, n is from 2 to 3 (preferably 2.5), and the weight ratio of the dialkyl sulfosuccinate compound to the secondary alcohol alkoxylate compound is from 9:1 to 1:9, alternatively from 1:3 to 1:9.

Compositions of the invention exhibit advantageously low dynamic surface tension. In some embodiments, the dynamic surface tension in an aqueous solution of the dialkyl sulfosuccinate compound and the secondary alcohol alkoxylate compound is 45 mN/m or less, alternatively 43 mN/m or less, alternatively 40 mN/m or less, or alternatively 38 mN/m or less, when measured at a concentration of 0.1 wt % at a temperature of 21 to 22° C. and 15 bubble/second according to the maximum-bubble-pressure method (see the Examples).

In some embodiments, an aqueous solution of the dialkyl sulfosuccinate compound and the secondary alcohol alkoxylate compound has an equilibrium surface tension of 30 mN/m or less at a concentration of 0.1 wt % at a temperature of 21 to 22° C. according to the Wilhelmy plate method.

Compositions of the inventions are useful as wetting agents in a wide variety of aqueous formulations. Because of their favorably dynamic surface tension properties, they particularly suited for use in formulations that are subjected to dynamic surface conditions. Examples include, but are not limited to, adhesive formulations, agrochemical formulations, coating formulations, ink formulations, formulations for use in textiles or leather processing, rolling coating formulations, curtain coating formulations, printing formulations, and spray coating formulations.

A person of ordinary skill in the art can readily determine the effective amount of the composition of the invention that should be used in a particular formulation. By way of non-limiting example, suitable amounts include from 0.01 to 5 percent, preferably 0.1 to 2 percent, by weight based on the total weight of the formulation.

The dialkyl sulfosuccinate compounds of formula I and secondary alcohol alkoxylate compounds of formula II may be purchased from commercial vendors or they may be prepared by those skilled in the art using literature techniques (see for instance international patent publication WO2012/071149 and U.S. Pat. No. 2,870,220, each of which is incorporated herein by reference).

Some embodiments of the invention will now be described in detail in the following Examples.

### EXAMPLES

### Materials

DOSS: sodium di-(2-ethylhexyl)sulfosuccinate

TMN-(EO)n: ethoxylated 2,6,8-trimethyl-4-nonanol (TMN) (formula II-A where R³ is isopropyl). The materials are commercially available from The Dow Chemical Company or made using a two-step ethoxylation process as described in U.S. Pat. No. 2,870,220

DIBC-(EO)n: ethoxylated diisobutyl carbinol (DIBC) (formula II-A where R³ is H) samples prepared as described below.

AEROSOL® WA-300 Surfactant, a blend of dioctyl sulfosuccinate and C12-16 alcohol ethoxylate: available from Cytec Chemical.

SURFYNOL® PSA336 surfactant, a blend of sodium dioctylsulfo succinate (DOSS) and ethoxylated 2,4,7,9-tetramethyl-5-decyne-4,7-diol: available from Air Products.

### Test Methods

Dynamic Surface Tension. Dynamic surface tension is measured on Kruss BP-2 Bubble Pressure Tensiometer. High purity nitrogen gas is used to generate bubbles. SH2031 hydrophobically coated glass capillary (from Kruss) with the inner diameter of 0.238 mm is used. Surface tension is measured in the range of surface age between 10 and 2000 ms. Surface tension is reported as a function of bubble surface age, in ms, and bubble frequency, bubbles/sec. The measurements are conducted at ambient temperature (21-22° C.).

Equilibrium Surface Tension. The surface tension of a surfactant solution is measured using Kruss K100 Surface Tensiometer fitted with a Wilhelmy platinum plate at ambient temperature (21-22° C.). Deionized water is used to make the solutions and the surface tension of the water is measured to be between 72 and 73 mN/m. The result are reported as a mean of five repeated testing values with the standard deviation <0.1 mN/m.

Ross-Miles Foam Test. Ross-Miles Foam test is conducted as described by ASTM method D1173 “Standard Test Method for Foaming properties of Surface Active Agents.” A glass pipet (“foam pipet”) is charged with 200 ml of the 0.1% aqueous surfactant solution, while the graduated glass tube (“foam receiver”) with ID=5.0 cm is filled with 50 ml of the same solution. After centering the pipet above the foam receiver, the aqueous solution in the pipet is allowed to drain 90 cm through air and splash into the solution in the foam receiver, thereby forming foam. The height of the foam layer, a measure of the volume of air which is incorporated into the foam, is recorded at 0 seconds, and at 5 minutes. Two measurements are made for each system at the ambient temperature and results are reported as the mean.

Contact Angle. Contact angle measurements are performed at ambient temperature utilizing Kruss DSA-100 Drop Shape Analyzer. The instrument has a movable sample stage. Kruss software, DSA3.exe, is used to control operation of the instrument and perform data analysis. The contact angle measurements are performed on a static sessile (i.e. sitting) drop. TEFLON® tape, parafilm, or silicone release paper are carefully placed on glass microscope slide, using a small amount of adhesive on each edge of the microscope slide to hold the Teflon tape on the surface. The substrate is placed on a sample stage, and 5 liquid drops are deposited on the substrate pro grammatically, using the procedure predefined via DSA software. An automated procedure is utilized. In this study, drop volume is 5 μL, rate of drop deposition is 6 μL/min, and measurement is made immediately after drop placement. Once the drop image is taken, the baseline is determined, left and right contact angles are determined by software, and the arithmetic mean of left and right contact angles is calculated for each drop. The result is reported as mean of the values from three groups of testing total 15 drops.

### Example 1

### Synthesis of DIBC-(EO)n

Diisobutyl carbinol (2000.6 g, water content 450.5 ppm) and diethylether complex of boron trifluoride (3.08 g) are charged into a previously nitrogen purged 9 L reactor. The mixture is heated at 55° C. with agitation under nitrogen. Ethylene oxide (EO, 740.2 g total) is metered into the reactor over approximately 2 hr at 55° C. After the EO feed is complete, the reactor contents are agitated at reaction temperature for an additional 2 hr to consume unreacted oxide (digest), and then cooled to ambient temperature. A portion of the reactor contents (819.3 g) are removed from the reactor as Crude Product 1. The reactor is pressurized to 16-20 psia with nitrogen and the remaining 1925.5 g of reactor contents are heated with agitation to 55° C. Ethylene oxide (345 g total) is metered into the reactor over approximately 1 hr. After the EO feed is complete, the reactor contents are agitated at reaction temperature for 4.5 hr to consume unreacted oxide, then cooled to ambient temperature. The product is drained from the reactor as Crude Product 2.

Crude Products 1 and 2 are washed first with 5% NaOH solution and then with water.

Into a 500-mL round bottom flask (RBF) is weighed 176 grams of the washed Crude Product 1. On a rotary evaporator equipped with oil pump and nitrogen line, the crude product is stripped under vacuum of 4 torr and temperature of 115° C. for 1 hour. The remains in the flask are collected as Sample 1 (77.1 g). Hydroxyl analysis (ASTM D 4274) indicates the average amount of EO adduction is 3.01. The sample is denoted as DIBC-3EO.

Similarly, 83.7 grams of washed Crude Product 1 in 500 mL RBF are stripped at vacuum of 3 torr and temperature of 70° C. for 1.5 h. The remains (47.7 grams) are collected as Sample 2 and hydroxyl analysis (ASTM D 4274) indicates the average amount of EO adduction is 2.31. The sample is denoted as DIBC-2.5EO.

Similarly, 420 grams of washed Crude Product 2 in 1 L flask is stripped at the vacuum of 3 torr and the temperature of 115° C. for 1 hour. The remains (236.5 grams) are collected as Sample 3. Hydroxyl analysis (ASTM D 4274) indicates the average amount of EO adduction is 3.98. The sample is denoted as DIBC-4EO.

The low EO-adducted products can be used as starter to add more EO to get higher EO-adducted products.

The DIBC ethoxylates can also be made through a one-step process by using double metal cyanide (DMC) as a catalyst as described in WO2012/071149.

### Example 2

Equilibrium surface tension, dynamic surface tension, Ross-Miles foaming heights, and contact angle on low energy surfaces are tested for the blends of DOSS and various ethoxylate TMN samples at different blending ratios. DOSS, Surfynol PSA336, and Aerosol WA-300 are included for comparison. All the samples are tested at 0.1 wt % total active concentration and at room temperature (21-22° C.). The results are summarized in Tables 1-2.

TABLE 1
Dynamic and Equilibrium Surface Tension

| | | | | DST @ 15 |
|---|---|---|---|---|
| Surfactant | | Wt % | Surface Tension | bubbles/sec |
| 1 | Surfactant 2 | Surfactant 2 | 0.1% | (mN/m) |
| DOSS | | 0 | 29.9 | 45.2 |
| DOSS | TMN-(EO)3 | 50 | 26.3 | 44.5 |
| DOSS | TMN-(EO)3 | 25 | 26.1 | 40.3 |
| DOSS | TMN-(EO)3 | 10 | 27.8 | 40.2 |
| DOSS | TMN-(EO)3 | 20 | 26.4 | 39.5 |
| DOSS | TMN-(EO)3 | 75 | 27.2 | 51.3 |
| DOSS | TMN-(EO)5 | 90 | 25.9 | 35.3 |
| DOSS | TMN-(EO)5 | 70 | 26.1 | 35.7 |
| DOSS | TMN-(EO)5 | 50 | 26.1 | 37.5 |
| DOSS | TMN-(EO)5 | 30 | 26.5 | 38.9 |
| DOSS | TMN-(EO)5 | 10 | 28.0 | 41.7 |
| DOSS | TMN-(EO)8 | 10 | | 51.5 |
| DOSS | TMN-(EO)8 | 20 | | 48.7 |
| DOSS | TMN-(EO)8 | 25 | | 48.2 |
| DOSS | TMN-(EO)8 | 50 | | 43.2 |
| DOSS | TMN-(EO)8 | 75 | | 40.3 |
| DOSS | TMN-(EO)8 | 80 | | 41.0 |
| DOSS | TMN-(EO)8 | 90 | | 40.0 |
| Surfynol | | | 31.2 | 39.0 |
| PSA336 | | | | |
| Aerosol | | | 26.1 | 51.3 |
| WA-300 | | | | |

TABLE 2
Ross Miles Foam and Contact Angle

| | | Wt % | Ross Miles Foam | | Contact Angle | | |
|---|---|---|---|---|---|---|---|
| | | Sur- | 0.1% (mm) | | 0.1% (°) | | |
| Surfac- | Surfac- | fac- | 0 | 5 | Tef- | Para- | Sili- |
| tant 1 | tant 2 | tant2 | min | min | lon | film | cone |
| DOSS | | 0 | 170 | 155 | 73 | 59 | 71 |
| DOSS | TMN-(EO)3 | 50 | 105 | 85 | 42 | 35 | |
| DOSS | TMN-(EO)3 | 25 | 150 | 130 | 45 | 38 | |
| DOSS | TMN-(EO)3 | 10 | 150 | 130 | 56 | 47 | |
| DOSS | TMN-(EO)3 | 20 | 150 | 130 | 49 | 40 | |
| DOSS | TMN-(EO)3 | 75 | 45 | 40 | 46 | 39 | |
| DOSS | TMN-(EO)5 | 90 | 145 | 138 | 42 | | 40 |
| DOSS | TMN-(EO)5 | 70 | 175 | 160 | 40 | | 41 |
| DOSS | TMN-(EO)5 | 50 | 170 | 160 | 44 | | 43 |
| DOSS | TMN-(EO)5 | 30 | 158 | 152 | 47 | | 48 |
| DOSS | TMN-(EO)5 | 10 | 160 | 150 | 61 | | 51 |
| DOSS | TMN-(EO)8 | 10 | | | | | |
| DOSS | TMN-(EO)8 | 20 | | | | | |
| DOSS | TMN-(EO)8 | 25 | | | | | |
| DOSS | TMN-(EO)8 | 50 | | | | | |
| DOSS | TMN-(EO)8 | 75 | | | | | |
| DOSS | TMN-(EO)8 | 80 | | | | | |
| DOSS | TMN-(EO)8 | 90 | | | | | |
| Surfynol | | | 170 | 130 | 67 | | 63 |
| PSA336 | | | | | | | |
| Aerosol | | | 138 | 138 | 69 | | 59 |
| WA-300 | | | | | | | |

As seen in Tables 1 and 2, by blending DOSS with ethoxylated TMN, in broad range of blending ratio, equilibrium surface tension, dynamic surface tension, and contact angle values are significantly reduced compared to DOSS itself. All the blends showed similar or lower foaming profiles compared to DOSS. In comparing with Surfynol PSA336, many examples of the inventive blends show lower dynamic surface tension. Importantly, the compositions of this invention can provide significantly lower equilibrium surface tension and contact angle on low energy surfaces, indicating they are better wetting agents than Surfynol PSA336. When compared with Aerosol WA-300, the exceptionally low equilibrium surface tension exhibited by Aerosol WA-300 can be well matched by many of the blends of this invention. The dynamic surface tension property and wetting on low energy surfaces of the compositions of this invention, however, are far more advantageous than Aerosol WA-300, indicating the blends of this invention is better wetting agents especially at dynamic conditions.

### Example 3

DIBC ethoxylate with the average EO number of about 2.5 (DIBC-2.5EO) is mixed with DOSS at the total active concentration of 0.1 wt % and the mixed solutions are measured for dynamic surface tension at room temperature (21-22° C.). The results are summarized in Table 3. As seen, by blending with DIBC-2.5EO, the dynamic surface tension at 15 bubbles/sec. of DOSS is reduced from about 45 mN/m to lower than 40 mN/m when the content of DIBC-2.5EO is 50% or higher. These results demonstrate that the DIBC ethoxylates/DOSS blend can be used to improve dynamic surface tension reduction property.

TABLE 3

| | | DIBC-2.5EO/DOSS (wt/wt) | | | | | | | | | DIBC- |
|---|---|---|---|---|---|---|---|---|---|---|---|
| Bubbles/Sec. | DOSS | 1:9 | 2:8 | 1:3 | 4:6 | 1:1 | 6:4 | 3:1 | 8:2 | 9:1 | 2.5EO |
| 1 | 34.5 | 34.1 | 33.5 | 33.4 | 33.3 | 32.8 | 32.8 | 32.9 | 33.2 | 33.3 | 34.3 |
| 4 | 37.3 | 36.8 | 36.0 | 36.2 | 35.3 | 35.0 | 34.9 | 35.0 | 35.0 | 34.9 | 35.7 |
| 6 | 39.2 | 38.4 | 37.6 | 36.9 | 36.3 | 36.0 | 35.8 | 35.9 | 35.7 | 35.9 | 36.3 |
| 10 | 41.9 | 40.8 | 39.3 | 39.2 | 38.1 | 37.5 | 37.5 | 37.3 | 37.2 | 37.1 | 37.4 |
| 15 | 45.2 | 43.3 | 41.5 | 41.2 | 40.3 | 39.5 | 39.3 | 38.7 | 38.7 | 38.7 | 39.0 |

### Example 4

### Use as Wetting Agent in Adhesive Formulation

A waterborne acrylic lamination adhesive base formulation in which no wetting agent is added is obtained from Beijing Decang Chemical Co. Ltd., China. Into the base formulation, different wetting surfactants are added at the dosage of 0.5 wt % to obtain the final formulated products. Surfynol 420 (ethoxylated (1.3) 2,4,7,9-tetramethyl-5-decyne-4,7-diol), Surfynol PSA-336 (both are from Air Products), and a blend of DIBC-2.5EO with DOSS at active weight ratio of 1:1 are used as wetting agent. The final formulated products are evaluated for film formation property on polypropylene (PP) and dynamic surface tension properties. In packaging film production, the coating process speed is often high, so low dynamic surface tension is important. The base formulation without adding any wetting agent is also included in the evaluation as reference.

The film coating on PP is performed by a K control coater (RK Print), the film weight is controlled at 2 gsm. The film forming property from the formulations are summarized in Table 4.

TABLE 4

| | Wetting Agent | | | |
|---|---|---|---|---|
| | | | | DIBC-2.5EO + |
| | None | Surfynol 420 | Surfynol PSA336 | Triton * GR-5M |
| Film Quality | Poor | OK | Good | Good |

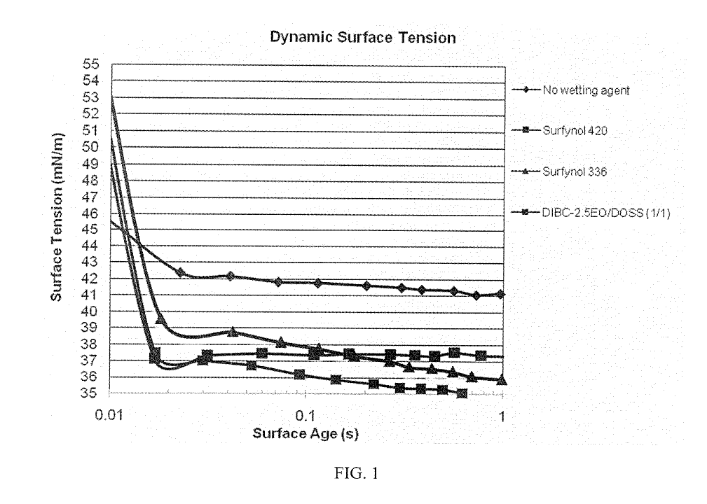

The dynamic surface tension values of the samples at different surface aging times are plotted in the FIG. 1.

As seen from FIG. 1, the sample without wetting agent added has high surface tension, indicating poor wetting under dynamic conditions. Although both Surfynol 420 and Surfynol PSA 336 can reduce the dynamic surface tension, the formulation using a blend of the invention (DIBC-2.5EO and DOSS) demonstrates the lowest dynamic surface tension.

### Example 5

### Heat Stability

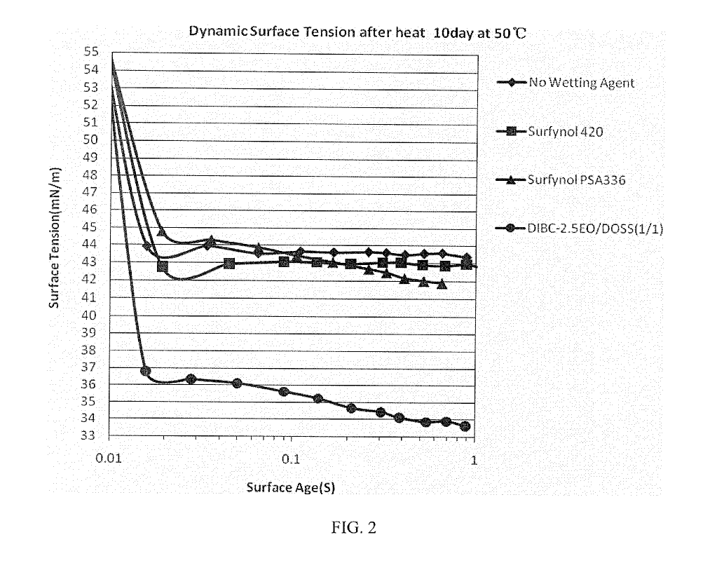

The formulated samples from Example 4 are sealed and placed in an oven at 50° C. for 10 days. The samples after the heating are tested for film formation properties and dynamic surface tension again. It is found that the sample with inventive blend (DIBC-2.5EO+DOSS) as the wetting agent shows good film formation and the coated film does exhibit a shrinking defect. Some shrinking defects are noticed in the films coated from the samples in which either Surfynol 420 or Surfynol PSA 336 is used as the wetting agent. The film coated from the reference formulation that contains no wetting agent has severe shrinking defects. In the dynamic surface tension tests, it is found that formulation using DIBC-2.5EO+DOSS as the wetting agent exhibited low dynamic surface tension, almost unchanged compared to the measurement made from the unheated sample. In contrast, the samples using Surfynol 420 or Surfynol PSA 336 as wetting agents exhibited high dynamic surface tensions that are close to the level observed with the reference formulation (see FIG. 2). The results indicate that waterborne adhesive formulations have excellent heat stability when a blended surfactant of this invention are used as additives.

1. A composition comprising:
(a) a dialkyl sulfosuccinate compound of formula I: 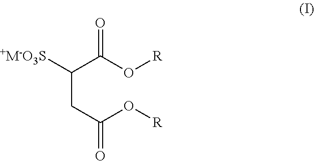
wherein R at each occurrence is C₇-C₉
alkyl, and M⁺ is a monovalent or divalent cation; and
(b) a secondary alcohol alkoxylate compound of formula II-A; 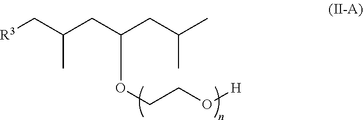
wherein R³ is selected from H and isopropyl and n is selected from 2, 3, 5 and 8;
and the weight ratio of the dialkyl sulfosuccinate compound to the secondary alcohol alkoxylate compound is from 9:1 to 1:9, and wherein an aqueous solution of the dialkyl sulfosuccmate compound and the secondary alcohol alkoxylate compound has a dynamic surface tension of 45 mN/m or less at a concentration of 0.1. wt. % at a temperature of 21 to 22° C. and 15 bubble/second according to the maximum-bubble-pressure method.

2. (canceled)

3. (canceled)

4. (canceled)

5. The composition of claim 1 wherein R³ is iso-propyl, n is 5, and the weight ratio of the dialkyl sulfosuccinate compound to the secondary alcohol alkoxylate compound is from 9:1 to 1:9, and wherein an aqueous solution of the dialkyl sulfosuccinate compound and the secondary alcohol alkoxylate compound has a dynamic surface tension of 45 mN/m or less at a concentration of 0.1 wt % at a temperature of 21 to 22° C. and 15 bubble/second according to the maximum-bubble-pressure method.

6. The composition of claim 1 wherein R³ is iso-propyl, n is 8, and the weight ratio of the dialkyl sulfosuccinate compound to the secondary alcohol alkoxylate compound is from 1:1 to 1:9, and wherein an aqueous solution of the dialkyl sulfosuccinate compound and the secondary alcohol alkoxylate compound has a dynamic surface tension of 45 mN/m or less at a concentration of 0.1 wt % at a temperature of 21 to 22° C. and 15 bubble/second according to the maximum-bubble-pressure method.

7. The composition of claim 1 wherein R³ is H, n is from 2 to 3, and the weight ratio of the dialkyl sulfosuccinate compound to the secondary alcohol alkoxylate compound is from 9:1 to 1:9, and wherein an aqueous solution of the dialkyl sulfosuccinate compound and the secondary alcohol alkoxylate compound has a dynamic surface tension of 45 mN/m or less at a concentration of 0.1 wt % at a temperature of 21 to 22° C. and 15 bubble/second according to the maximum-bubble-pressure method.

8. (canceled)

9. A method for reducing surface tension in a formulation, the method comprising adding to the formulation, 1 of 2 percent by weight based on total weight of the formulation of the composition of claim 1.

10. A formulation containing a surfactant to reduce surface tension, the formulation being selected from an adhesive formulation, an agrochemical formulation, a coating formulation, an ink formulation, an agrochemical formulation, a formulation for use in textiles or leather, a rolling coating formulation, a curtain coating formulation, a printing formulation, and a spray coating formulation, wherein the surfactant comprises the composition of claim 1.
